(19) United States
(12) Patent Application Publication
(10) Pub. No.: US 2021/0199447 A1
(43) Pub. Date: Jul. 1, 2021

(54) INFORMATION PROCESSING APPARATUS AND INFORMATION PROCESSING METHOD

(71) Applicant: CLARION CO., LTD., Saitama (JP)

(72) Inventors: Megumi KAWATA, Cypress, CA (US); Norikazu NARA, Cypress, CA (US)

(73) Assignee: CLARION CO., LTD., Saitama (JP)

(21) Appl. No.: 16/727,121

(22) Filed: Dec. 26, 2019

(51) Int. Cl. G01C 21/34; G01C 21/36; G06N 20/00; H04W 4/029

(52) U.S. Cl. CPC G01C 21/343; G01C 21/3484; H04W 4/029; G01C 21/3476; G06N 20/00; G01C 21/3617

(57) ABSTRACT

A server apparatus includes a communication section; a generation section that based on position information pieces received by the communication section from an in-vehicle device, generates trip data including position information pieces of departure points and arrival points of a vehicle in which the in-vehicle device is mounted; an extraction section that based on the trip data, extracts a plurality of first candidate areas associated with position information pieces set as departure points, a number of which is equal to or exceeding a predetermined value, and for each of the plurality of first candidate areas, second candidate areas associated with position information pieces set as arrival points, a number of which is equal to or exceeding a predetermined value, in a case of departure from the departure points in the first candidate area; an acquisition section that acquires usage information pieces of lands including the first candidate areas and the second candidate areas; and an estimation section that estimates an intended candidate area based on the usage information pieces acquired by the acquisition section, the number of position information pieces of departure points included in the first candidate areas and the number of position information pieces of arrival points included in the second candidate areas.

### BACKGROUND OF THE INVENTION

### Field of the Invention

The present invention relates to an information processing apparatus and an information processing method.

### Description of the Related Art

Conventionally, apparatuses that estimate a purpose of dwelling of a user at a position indicated by position information have been known. For example, Japanese Patent Laid-Open No. 2015-82137 discloses that a sum of the number of times of selection as a departure point and the number of times of selection as a destination is calculated as a degree of importance, a purpose of dwelling of a dwell cluster, the calculated degree of importance of the dwell cluster being largest, is estimated as home and a purpose of dwelling of a dwell cluster, the degree of importance of the dwell cluster being second largest, is estimated as a workplace.

However, depending on the behavior of the user, the dwell cluster with the largest degree of importance is not necessarily home and the dwell cluster with the second-largest degree of importance is not necessarily a workplace.

The present invention has been made in view of the above circumstances and an object of the present invention is to enhance accuracy of estimation of an intended candidate area.

### SUMMARY OF THE INVENTION

In order to achieve the above object, an information processing apparatus according to an aspect of the present invention includes: a communication section; a generation section that based on position information pieces received by the communication section from an in-vehicle device, generates trip data including position information pieces of departure points and arrival points of a vehicle in which the in-vehicle device is mounted; an extraction section that based on the trip data, extracts a plurality of first candidate areas associated with position information pieces set as departure points, a number of which is equal to or exceeding a predetermined value, and for each of the plurality of first candidate areas, second candidate areas associated with position information pieces set as arrival points, a number of which is equal to or exceeding a predetermined value, in a case of departure from the departure points in the first candidate area; an acquisition section that acquires usage information pieces of lands including the first candidate areas and usage information pieces of lands including the second candidate areas; and an estimation section that estimates an intended candidate area based on the usage information pieces acquired by the acquisition section, the number of position information pieces of departure points included in the first candidate areas and the number of position information pieces of arrival points included in the second candidate areas.

In the information processing apparatus, the extraction section performs clustering of the first candidate areas and the second candidate areas using the trip data as learning data.

In the information processing apparatus, the extraction section performs clustering of the learning data via mechanical learning.

In the information processing apparatus, the estimation section estimates a first candidate area or a second candidate area that has the usage information piece acquired by the acquisition section indicating a residential area, and a largest number of position information pieces of departure points and arrival points, as a house area in which a house of a user of the vehicle is located, and estimates a position of the house based on the position information pieces included in the first candidate area or the position information pieces included in the second candidate area.

In the information processing apparatus, the estimation section estimates a first candidate area or a second candidate area that has the usage information piece acquired by the acquisition section indicating a business area, and a largest number of position information pieces of departure points and arrival points, as a workplace area in which a workplace of the user of the vehicle is located, and estimates a position of the workplace based on the position information pieces included in the first candidate area or the position information pieces included in the second candidate area.

In the information processing apparatus, the estimation section excludes a first candidate area and a second candidate area with time lengths of parking of the vehicle in each of the first candidate area and the second candidate area being equal to or below a set time length set in advance, from among the plurality of first candidate areas and second candidate areas extracted by the extraction section, from candidates for estimation of the intended candidate area.

In the information processing apparatus, the communication section receives identification information for identifying a wireless network to which a mobile device carried by the user of the vehicle was connected and a position information piece, from the mobile device, and the estimation section excludes a first candidate area and a second candidate area, the identification information of each of the first candidate area and the second candidate area including a word related to a facility name, from among the plurality of first candidate areas and second candidate areas extracted by the extraction section, from candidates for the house area.

In the information processing apparatus, the communication section receives identification information for identifying a wireless network to which a mobile device carried by the user of the vehicle was connected and a position information piece, from the mobile device, and the estimation section excludes a first candidate area and a second candidate area, the identification information of each of the first candidate area and the second candidate area including no word related to a facility name, from among the plurality of first candidate areas and second candidate areas extracted by the extraction section, from candidates for the workplace area.

The information processing apparatus includes a storage section that stores a database registering usage for each area, and the acquisition section acquires the usage information pieces with reference to the database stored in the storage section.

In the information processing apparatus, the acquisition section controls the communication section to transmit the position information pieces to an external apparatus that stores a database registering usage for each area and receive usage information pieces of areas including the positions indicated by the position information pieces from the external apparatus, the usage information pieces being transmitted from the external apparatus.

An information processing method according to an aspect of the present invention includes: a step of receiving position information pieces from an in-vehicle device mounted in a vehicle; a step of generating, based on the received position information pieces, trip data including position information pieces of departure points and arrival points of the vehicle in which the in-vehicle device is mounted; a step of extracting, based on the trip data, a plurality of first candidate areas associated with position information pieces set as departure points, a number of which is equal to or exceeding a predetermined value, and for each of the plurality of first candidate areas, second candidate areas associated with position information pieces set as arrival points, a number of which is equal to or exceeding a predetermined value, in a case of departure from the departure points in the first candidate area; a step of acquiring usage information pieces of lands including the first candidate areas and usage information pieces of lands including the second candidate areas; and a step of estimating an intended candidate area based on the acquired usage information pieces, the number of position information pieces of departure points included in the first candidate areas and the number of position information pieces of arrival points included in the second candidate areas.

In the information processing method, the step of extracting includes performing clustering of the first candidate areas and the second candidate areas using the trip data as learning data.

In the information processing method, the step of extracting includes performing clustering of the learning data via mechanical learning.

In the information processing method, the step of estimating includes estimating a first candidate area or a second candidate area that has the acquired usage information piece indicating a residential area, and a largest number of position information pieces of departure points and arrival points, as a house area in which a house of a user of the vehicle is located, and estimating a position of the house based on the position information pieces included in the first candidate area or the position information pieces included in the second candidate area.

In the information processing method, the step of estimating includes estimating a first candidate area or a second candidate area that has the acquired usage information piece indicating a business area, and a largest number of position information pieces of departure points and arrival points, as a workplace area in which a workplace of the user of the vehicle is located, and estimating a position of the workplace based on the position information pieces included in the first candidate area or the position information pieces included in the second candidate area.

In the information processing method, the step of estimating includes excluding a first candidate area and a second candidate area with time lengths of parking of the vehicle in each of the first candidate area and the second candidate area being equal to or below a set time length set in advance, from among the plurality of first candidate areas and second candidate areas extracted by the step of extracting, from candidates for estimation of the intended candidate area.

In the information processing method, the step of receiving includes receiving identification information for identifying a wireless network to which a mobile device carried by the user of the vehicle was connected and a position information piece, from the mobile device, and the step of estimating includes excluding a first candidate area and a second candidate area, the identification information of each of the first candidate area and the second candidate area including a word related to a facility name, from among the plurality of first candidate areas and second candidate areas extracted by the step of extracting, from candidates for the house area.

In the information processing method, the step of receiving includes receiving identification information for identifying a wireless network to which a mobile device carried by the user of the vehicle was connected and a position information piece, from the mobile device, and the step of estimating includes excluding a first candidate area and a second candidate area, the identification information of each of the first candidate area and the second candidate area including no word related to a facility name, from among the plurality of first candidate areas and second candidate areas extracted by the step of extracting, from candidates for the workplace area.

The information processing method includes a step of retrieving a facility name of a facility present at a position indicated by a position information piece, and the step of estimating includes, if the position indicated by the position information piece is a position, for which a plurality of facility names have been retrieved by the step of retrieving, selecting one facility name based on the word included in the identification information and associating the selected facility name with the position information piece.

The information processing method includes a step of retrieving a facility name of a facility present at a position indicated by a position information piece, and the step of estimating includes, if the position indicated by the position information piece is a position, for which a plurality of facility names have been retrieved by the step of retrieving, selecting one facility name based on the word included in the identification information and associating the selected facility name with the position information piece.

The aspect of the present invention enables enhancement of accuracy of estimation of an intended candidate area.

### BRIEF DESCRIPTION OF THE DRAWINGS

FIG. 1 is a system configuration diagram of a system according to a first embodiment;

FIG. 2 is a block diagram illustrating a configuration of a mobile device;

FIG. 3 is a block diagram illustrating a configuration of an in-vehicle device;

FIG. 4 is a block diagram illustrating a configuration of a server apparatus;

FIG. 5 is a diagram illustrating a configuration of a user management table;

FIG. 6 is a diagram illustrating a configuration of a position database;

FIG. 7 is a diagram illustrating a configuration of a site registration table;

FIG. 8 is a diagram illustrating an example of a coordinate plane on which coordinate information pieces are plotted;

FIG. 9 is a diagram illustrating an overview of clustering;

FIG. 10 is a flowchart illustrating operation of a server apparatus upon receiving position information;

FIG. 11 is a flowchart illustrating a procedure of processing for estimating a house and a workplace of a user, which is executed by the server apparatus;

FIG. 12 is a flowchart illustrating a subsequent procedure for estimating a house and a workplace of a user, which is executed by the server apparatus;

FIG. 13 is a flowchart illustrating processing for estimating whether or not an arrival point is a house or a workplace; and

FIG. 14 is a system configuration diagram of a system according to a second embodiment.

### DETAILED DESCRIPTION OF THE PREFERRED EMBODIMENTS

### First Embodiment

Embodiments of the present invention will be described below with reference to the accompanying drawings.

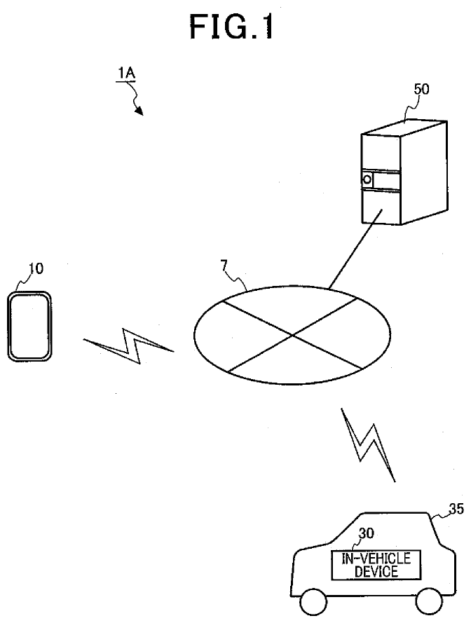

FIG. 1 is a system configuration diagram of a system 1A to which the present invention is applied.

The present embodiment provides a system 1A including a mobile device 10, an in-vehicle device 30 and a server apparatus 50, and these devices and apparatus are interconnected via a communication network 7 so as to enable mutual data communication. The communication network 7 is built by, for example, the Internet, a LAN (local area network), a WAN (wide area network), a dedicated communication channel, a mobile communication network including, e.g., a base station, and/or a gateway.

For the mobile device 10, for example, a smartphone, a PDA (personal digital assistant), a tablet computer or a laptop computer is used. The in-vehicle device 30 is a device mounted in a vehicle 35 owned by a user of the mobile device 10.

The mobile device 10 performs an arithmetic operation to obtain a latitude and a longitude indicating a current position based on GPS (global positioning system) radio waves received from a GPS satellite. The mobile device 10 performs an arithmetic operation to calculate a latitude and a longitude at regular interval set in advance and uploads the latitude and the longitude obtained by the arithmetic operation to the server apparatus 50 as position information.

Upon the user getting in the vehicle 35 and an ignition key of the vehicle 35 being turned on, the in-vehicle device 30 performs an arithmetic operation to obtain a latitude and a longitude based received GPS radio waves and uploads the latitude and the longitude obtained by the arithmetic operation to the server apparatus 50 as position information. Also, upon the ignition key of the vehicle 35 being turned off, the in-vehicle device 30 uploads a latitude and a longitude obtained by an arithmetic operation to the server apparatus 50 as position information.

The server apparatus 50 corresponds to an example of “information processing apparatus” in the present invention, and estimates a house and/or a workplace of the user based on the position information pieces received from the mobile device 10 or the in-vehicle device 30.

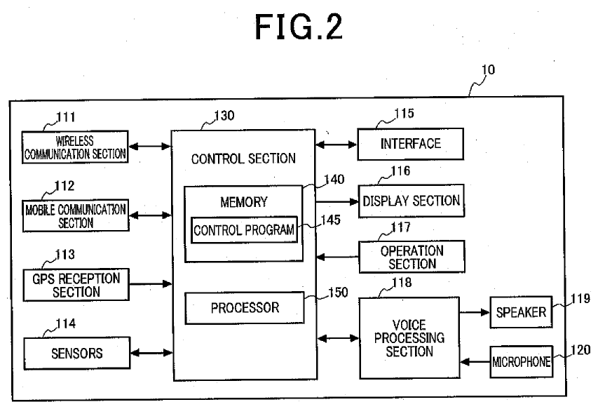

FIG. 2 is a block diagram illustrating a configuration of the mobile device 10.

The mobile device 10 includes a wireless communication section 111, a mobile communication section 112, a GPS reception section 113, sensors 114, an interface 115, a display section 116, an operation section 117, a voice processing section 118, a speaker 119, a microphone 120 and a control section 130.

The wireless communication section 111 performs wireless communication with a wireless LAN access point or an external device that allows wireless LAN communication, according to, for example, a wireless LAN standard such as IEEE802.11a/b/g/n.

The mobile communication section 112, which includes, e.g., an antenna and a wireless communication channel (illustration of both omitted), performs mobile communication via a mobile communication network. The mobile communication network is a communication network included in the communication network 7. A communication method of the mobile communication section 112 may be 3G (third generation mobile communication system), LTE (Long Term Evolution: registered trademark) or 4G (fourth generation mobile communication system).

The GPS reception section 113 receives GPS radio waves transmitted from a plurality of GPS satellites. The GPS reception section 113 demodulates the received GPS radio waves to retrieve a GPS signal. The GPS reception section 113 outputs the retrieved GPS signal to the control section 130.

The sensors 114 include an acceleration sensor, a gyroscope sensor and a geomagnetic sensor.

The acceleration sensor detects accelerations in respective directions of three axes orthogonal to one another, and the gyroscope sensor detects angular velocities around the three axes orthogonal to one another. Also, the geomagnetic sensor detects magnetic fields in the respective directions of the three axes orthogonal to one another.

The interface 115 is a section of connection to an external apparatus. A cable is connected to the interface 115. The mobile device 10 is connected to the in-vehicle device 30, which is an external apparatus, via the cable.

The display section 116, which includes a display such as a liquid-crystal panel or an organic EL (Electro Luminescence) panel, displays an image on the display under the control of the control section 130.

The operation section 117 includes, for example, a power supply switch and operation buttons, and receives an operation by a user. Also, the operation section 117 includes a touch sensor that detects an operation of touching the display, and outputs coordinate information indicating a touch position the user touches with, e.g., his/her finger to the control section 130.

The speaker 119 and the microphone 120 are connected to the voice processing section 118.

The voice processing section 118 decodes voice data input from the control section 130 and outputs the decoded voice data to the speaker 119. Also, the voice processing section 118 converts voice input by the microphone 120 into digital voice data and outputs the converted voice data to the control section 130.

The control section 130 is a computer including a memory 140 and a processor 150.

The memory 140 includes, for example, a non-volatile storage device such as an EEPROM (electronically erasable programmable read-only memory) or a flash memory and a volatile storage device such as a RAM (random access memory). The memory 140 stores a control program 145 including, e.g., an OS (operating system) and an application program.

The processor 150 is an arithmetic device such as a CPU (central processing unit) or a microprocessor. The processor 150 may be configured by a single processor or may be configured by or a plurality of processors. Also, the processor 150 may be configured by an SoC (system on chip) integrated with a part or an entirety of the memory 140 or another circuit. Also, the processor 150 may be configured by a combination of a CPU that executes a program and a DSP (digital signal processor) that executes predetermined arithmetic processing. Furthermore, the processor 150 may have a configuration in which all of functions of the processor 150 are implemented in hardware or a configuration using a programmable device.

In the control section 130, the processor 150 executes a set of commands described in the control program 145 to perform an arithmetic operation of data and control and thereby control the respective sections of the mobile device 10.

For example, the control section 130 connects to the communication network 7 by controlling the wireless communication section 111 or the mobile communication section 112 and performs data communication with the server apparatus 50 connected to the communication network 7. Also, the control section 130 downloads, for example, image data selected via an operation by the user, from the server apparatus 50 and causes an image based on the downloaded image data to be displayed on the display section 116.

Furthermore, the control section 130 performs an arithmetic operation to obtain a latitude and a longitude indicating a current position of the mobile device 10 based on a GPS signal input from the GPS reception section 113, at regular intervals set in advance. The control section 130 uploads position information including the latitude and the longitude obtained by the arithmetic operation, time information of a time of the obtainment of the latitude and the longitude and a device ID, which is identification information of the mobile device 10, to the server apparatus 50 at regular intervals set in advance.

Also, upon connection to a wireless LAN access point by the wireless communication section 111, the control section 130 acquires an SSID (service set identifier) of the connected access point. An SSID is identification information for identifying a wireless network created by an access point and indicates a network name of the wireless network. For example, if the access point is an access point installed in a shop or a facility, the SSID includes a word related to a name of the shop or the facility. The control section 130 uploads the acquired SSID, the word related to the shop name or the facility name included in the SSID, the position information including the latitude and longitude obtained by the arithmetic operation based on the GPS signal, the time information and the device ID to the server apparatus 50. Hereinafter, a word related to a name of a shop or a facility is referred to as “facility word”.

The present embodiment will be described in terms of a case where the wireless communication section 111 performs wireless communication using a wireless LAN and uploads an SSID of an access point to the server apparatus 50; however, the wireless communication section 111 may perform wireless communication using Bluetooth (registered trademark). For example, a facility word may be included in a device name displayed when pairing is performed and the control section 130 may extract the facility word from the device name and upload position information including the extracted facility word to the server apparatus 50.

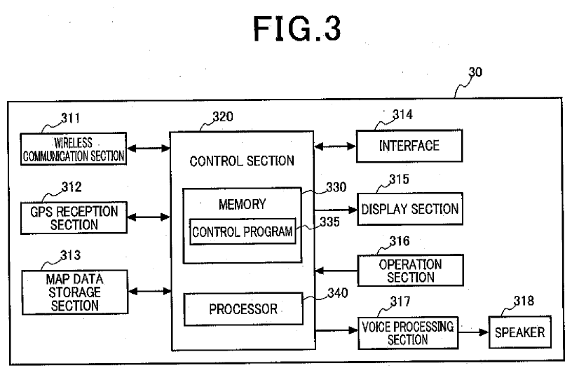

FIG. 3 is a block diagram illustrating a configuration of the in-vehicle device 30.

The configuration of the in-vehicle device 30 will be described with reference to FIG. 3. The in-vehicle device 30 includes a wireless communication section 311, a GPS reception section 312, a map data storage section 313, an interface 314, a display section 315, an operation section 316, a voice processing section 317, a speaker 318 and a control section 320.

The wireless communication section 311 is configured by, for example, a TCU (telematics control unit) and performs wireless communication with a non-illustrated base station apparatus according to a communication standard such LTE or 4G.

The GPS reception section 312 receives GPS radio waves transmitted from a plurality of GPS satellites. The GPS reception section 312 demodulates the received GPS radio waves to retrieve a GPS signal. The GPS reception section 312 outputs the retrieved GPS signal to the control section 320.

The map data storage section 313 includes, for example, a storage device such as an HDD (hard disk drive) or an SSD (solid-state drive). The map data storage section 313 stores map data. The map data includes information relating to nodes indicating intersections and other connection points in a road network, information indicating links each indicating a rode section between nodes, and information relating to administrative districts on a map and names of, e.g., roads, facilities and intersections.

The interface 314 is a section of connection to an external apparatus. A cable is connected to the interface 314. The in-vehicle device 30 is connected to the mobile device 10, which is an external apparatus, via the cable.

Also, the interface 314 is connected to, for example, an in-vehicle communication network built in the vehicle 35. The in-vehicle communication network is a network complying with an arbitrary standard, for example, CAN (Controller Area Network), LIN (Local Interconnect Network), LAN (Local Area Network) or FlexRay (registered trademark). The interface 314 receives data from an ECU (electronic control unit) mounted in the vehicle 35. The ECU is a control device that is connected to the in-vehicle communication network and controls traveling of the vehicle 35 by, for example, controlling driving of, e.g., an engine, a transmission and a braking device. The data transmitted by the ECU to the in-vehicle device 30 includes vehicle speed data indicating a vehicle speed of the vehicle 35, the vehicle speed being measured by a vehicle speed sensor.

The display section 315, which includes a display such as a liquid-crystal panel or an organic EL panel, displays an image on the display under the control of the control section 320.

The operation section 316 includes, for example, a power supply switch and operation buttons, and receives an operation by a user. Also, the operation section 316 includes a touch sensor that detects an operation of touching the display, and outputs coordinate information indicating a touch position where the user touches with, e.g., his/her finger to the control section 320.

The voice processing section 317 decodes voice data input from the control section 320 and outputs the decoded voice data to the speaker 318. For example, voice for routing assistance is output from the speaker 318.

The control section 320 is a computer including a memory 330 and a processor 340.

The memory 330 includes, for example, a non-volatile storage device such as a flash memory or an EEPROM and a volatile storage device such as a RAM. The memory 330 stores a control program 335.

The processor 340 is an arithmetic device such as a CPU or a microprocessor. The processor 340 may be configured by a single processor or a plurality of processors. Also, the processor 340 may be configured by an SoC integrated with a part or an entirety of the memory 330 or another circuit. Also, the processor 340 may be configured by a combination of a CPU that executes a program and a DSP that executes predetermined arithmetic processing. Furthermore, the processor 340 may have a configuration in which all of functions of the processor 340 are implemented in hardware or a configuration using a programmable device.

In the control section 320, the processor 340 executes a set of commands described in the control program 335 to perform an arithmetic operation of data and control and thereby controls the respective sections of the in-vehicle device 30. For example, the control section 320 reads map data corresponding to a latitude and a longitude input from the GPS reception section 312, from the map data storage section 313, and causes an image based on the read map data to be displayed on the display section 315. Also, the control section 320 connects to the communication network 7 by controlling the wireless communication section 311 and performs data communication with the server apparatus 50.

Also, upon the ignition key being turned on and the engine of the vehicle 35 starting, the control section 320 performs an arithmetic operation to obtain a latitude and a longitude indicating a current position of the in-vehicle device 30 based on a GPS signal input from the GPS reception section 312. The control section 320 uploads position information including the latitude and the longitude obtained at the time of the start of the engine, a time of the obtainment of the latitude and the longitude, start data indicating that the latitude and the longitude form information of a departure point of a trip and an in-vehicle device ID, which is identification information of the in-vehicle device 30, to the server apparatus 50.

Also, upon the ignition key being turned off and the engine of the vehicle 35 stopping, the control section 320 performs an arithmetic operation to obtain a latitude and a longitude indicating a current point of the in-vehicle device 30 based on a GPS signal input from the GPS reception section 312. The control section 320 uploads position information including the latitude and the longitude obtained at the time of the stoppage of the engine, a time of the obtain of the latitude and the longitude, end data indicating that the latitude and the longitude form information of an arrival point of a trip and the in-vehicle device ID, which is identification information of the in-vehicle device 30, to the server apparatus 50.

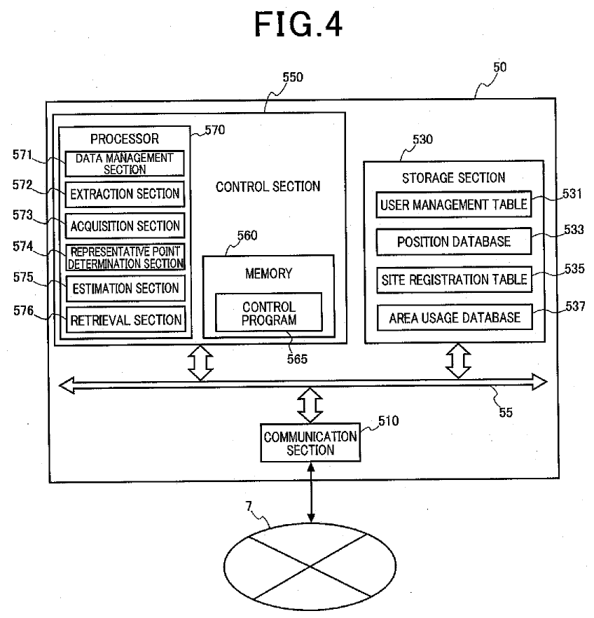

FIG. 4 is a block diagram illustrating a configuration of the server apparatus 50.

The configuration of the server apparatus 50 will be described with reference to FIG. 4.

The server apparatus 50 includes a communication section 510, a storage section 530 and a control section 550.

The communication section 510 is connected to the communication network 7 and performs data communication with another device via the communication network 7.

The storage section 530 is configured by, for example, a storage device such as an HDD or an SSD.

The storage section 530 stores a user management table 531, a position database 533, a site registration table 535 and an area usage database 537.

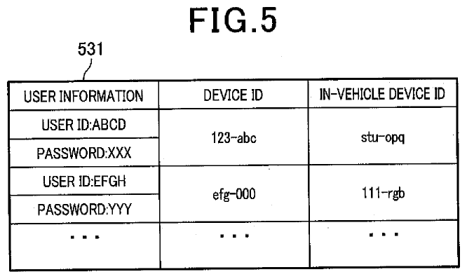

FIG. 5 is a diagram illustrating a configuration of the user management table 531.

The user management table 531 is a table in which user information pieces for identifying respective users are registered in association with respective device IDs of mobile devices 10 used by the users in the respective user information pieces and respective in-vehicle devices ID of in-vehicle devices 30 used by the users. Each user information piece includes, for example, a user ID for uniquely identifying a user that has performed user registration and a password set by the user.

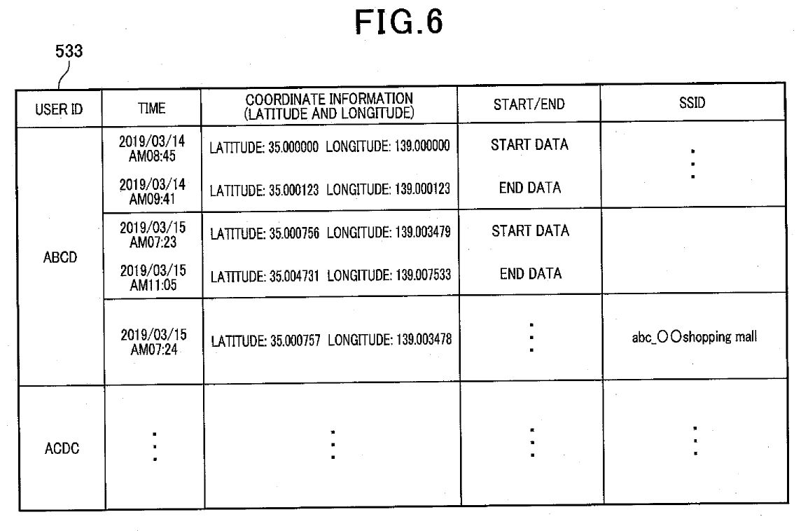

FIG. 6 is a diagram illustrating a configuration of the position database 533.

In the position database 533, position information pieces received from mobile devices 10 or in-vehicle devices 30 are registered in association with respective user IDs.

If position information is position information received from an in-vehicle device 30, a time, a latitude and a longitude and start data or end data are registered in association with a relevant user ID. Also, if position information is position information received from a mobile device 10, a time, a latitude and a longitude and an SSID are registered in association with a relevant user ID. Note that an SSID is information transmitted from a mobile device 10 when a wireless communication section 111 of the mobile device 10 is connected to a wireless LAN access point and a relevant wireless communication section 111 acquires the SSID from the access point, and is not always included in position information received from the mobile device 10. Hereinafter, a latitude and a longitude registered in the position database 533 are collectively referred to as “coordinate information”.

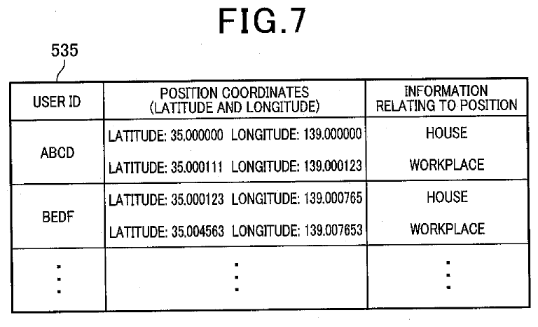

FIG. 7 is a diagram illustrating a configuration of the site registration table 535.

In the site registration table 535, coordinate information pieces and site information pieces are registered in association with respective user IDs. Each site information piece is information estimated based on, e.g., a latitude and a longitude by the control section 550, and includes, for example, a house or a workplace of a user.

The area usage database 537 is a database in which land usage for each area is registered. In the area usage database 537, for example, range information indicating a range of each area and usage information of the area indicated by the range information are registered in association with each other. Examples of the usage information include three types of information such as “residential area”, “business area” and “other”. Also, the area usage database 537 may be created based on, for example, use districts set based on the City Planning Act of Japan. Examples of the use districts include information such as category 1 and 2 low-rise exclusive residential districts, category 1 and 2 medium-to-high-rise exclusive residential districts, category 1 and 2 residential districts, neighborhood commercial districts and commercial districts.

The control section 550 is a computer including a memory 560 and a processor 570.

The memory 560 is, for example, a non-volatile storage device such as a flash memory or an EEPROM. Also, the memory 560 may include a volatile storage device such as a RAM. The memory 560 stores a control program 565.

The processor 570 is an arithmetic device configured by a CPU (central processing unit) or a microcomputer. The processor 570 may be configured by a single processor or can be configured by a plurality of processors. Also, the processor 570 may be configured by an SoC integrated with a part or an entirety of the memory 560 or another circuit. Also, the processor 570 may be configured by a combination of a CPU that executes a program and a DSP that executes predetermined arithmetic processing. Furthermore, the processor 570 may have a configuration in which all of functions of the processor 570 are implemented in hardware or a configuration using a programmable device.

The control section 550 includes a data management section 571, an extraction section 572, an acquisition section 573, a representative point determination section 574, an estimation section 575 and a retrieval section 576 as functional blocks. These functional blocks are ones conveniently indicating respective functions that are each provided by execution of a set of commands described in the control program 565 and data calculation and control by the processor 570, using blocks and are not intended to indicate specific application programs and hardware.

The data management section 571 registers position information received from a mobile device 10 or an in-vehicle device 30 in the position database 533.

If position information is received from an in-vehicle device 30, the data management section 571 retrieves an in-vehicle device ID included in the received position information and acquires a user ID associated with the retrieved in-vehicle device ID from the user management table 531. The data management section 571 registers the position information acquired from the in-vehicle device 30, in association with the acquired user ID.

Also, if position information is received from a mobile device 10, the data management section 571 retrieves a device ID included in the received position information and acquires a user ID associated with the retrieved device ID from the user management table 531. The data management section 571 registers the position information acquired from the mobile device 10, in association with the acquired user ID.

Also, the data management section 571 corresponds to “generation section” in the present invention and generates trip data including position information pieces of a departure point and an arrival point of a vehicle 35.

Position information received by the server apparatus 50 from an in-vehicle device 30 include start data indicating that relevant coordinate information of a departure point of a relevant trip or end data indicating that relevant coordinate information is information of an arrival point of a relevant trip. The data management section 571 generates trip data indicating a start position and an arrival position of one trip of a vehicle 35 by registering position information including start data and position information including end data in a same record in the position database 533.

The extraction section 572 extracts first candidate areas and second candidate areas based on coordinate information pieces registered in the position database 533. A first candidate area is an area including a number of coordinate information pieces set as a departure point, the number being equal to or exceeding a predetermined value. Also, a second candidate area is an area including a number of coordinate information pieces set as an arrival point. More specifically, a second candidate area is an area at which a vehicle 35 departed from a departure point in a first candidate area extracted by the extraction section 572 arrived, the area including a number of coordinate information pieces of arrival points, the number being equal to or exceeding a predetermined value.

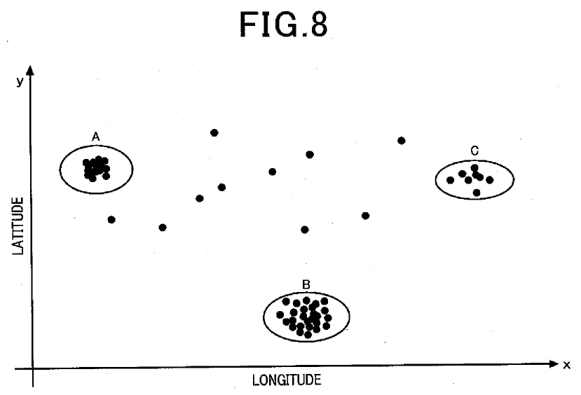

First, the extraction section 572 selects a processing object user ID. The extraction section 572 sequentially reads records of the selected user ID from the position database 533 and plots coordinate information pieces of departure points associated with start data on a coordinate plane. For example, latitudes are associated with an ordinate axis y of the coordinate plane, and for example, longitudes are associated with an abscissa axis x. FIG. 8 is a diagram illustrating an example of the coordinate plane on which coordinate information pieces of departure points are plotted.

Next, based on distribution of the coordinate information pieces plotted on the coordinate plane, the extraction section 572 extracts first candidate areas. The extraction section 572 may extract areas each including a number of coordinate information pieces falling within a figure of a size set in advance, the number being equal to or exceeding a predetermined value, as first candidate areas while moving the figure on the coordinate plane. Alternatively, the extraction section 572 may calculate a distribution density of coordinate information pieces and extract areas whose respective calculated distribution densities are equal to or exceed a predetermined value as first candidate areas. In the example illustrated in FIG. 8, three areas, A, B and C, are detected as first candidate areas.

After the extraction of the first candidate areas, next, the extraction section 572 extracts second candidate areas. For each of the extracted first candidate areas, the extraction section 572 acquires trip data belonging to the first candidate area and plots coordinate information pieces of arrival points included in the acquired trip data on a coordinate plane. Based on distribution of the coordinate information pieces plotted on the coordinate plane, the extraction section 572 extracts second candidate areas. The extraction of the second candidate areas is performed in a manner that is similar to that of the extraction of the first candidate areas.

Alternatively, the extraction section 572 may perform machine learning using trip data as learning data to generate a prediction function and based on the generated prediction function, extract first candidate areas. For the machine learning, for example, a clustering (unsupervised classification) method such as K-means clustering or a GMM (Gaussian mixture model) can be used. Also, the prediction function is, for example, a learning model in which arbitrary coordinate information (x, y) is input and a Gaussian distribution (cluster) with a largest probability of occurrence of the input coordinate information is output.

The present embodiment will be described taking a case where the extraction section 572 performs clustering to extract first candidate areas as an example.

First, the extraction section 572 performs clustering of coordinate information pieces of departure points included in trip data. Clusters extracted via the clustering by the extraction section 572 are referred to as departure point clusters. The departure point clusters correspond to first candidate areas.

Next, the extraction section 572 performs clustering of times at the departure points in the trip data. For each departure point cluster, the extraction section 572 performs clustering of times at departure points in trip data classified into the departure point cluster. Clusters generated by the clustering of the times at the departure points are referred to as departure time clusters.

Furthermore, the extraction section 572 performs clustering of coordinate information pieces of arrival points in the trip data. For each departure time cluster, the extraction section 572 performs clustering of coordinate information pieces of arrival points in trip data classified into the departure time cluster. Clusters generated by the clustering of the coordinate information pieces of the arrival points are referred to as arrival point clusters.

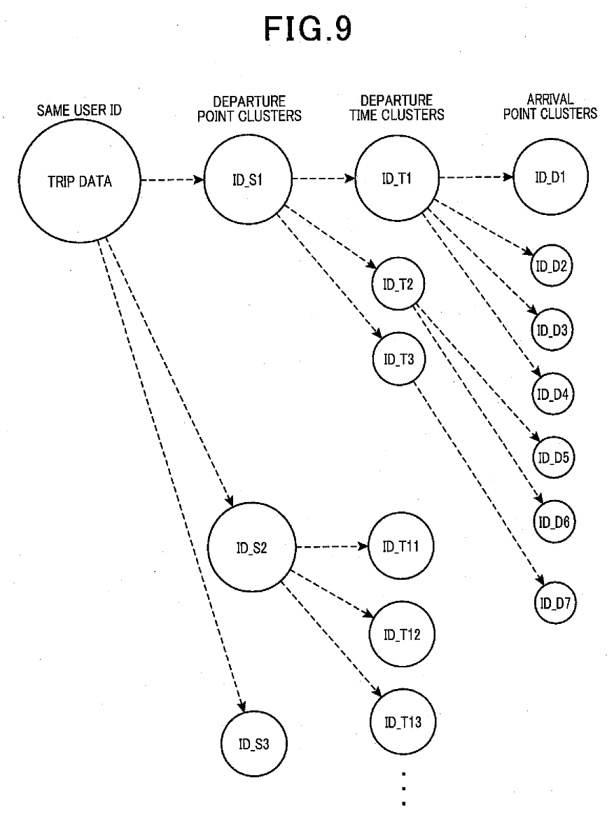

FIG. 9 is a diagram of clustering.

First, the extraction section 572 reads trip data associated with a same user ID from the position database 533 and performs clustering of coordinate information pieces of departure points. It is assumed that three departure point clusters having respective cluster IDs of “ID_S1”, “ID_S2” and “ID_S3” are generated as a result of the clustering of coordinate information pieces of the departure points.

Next, the extraction section 572 performs clustering of times at departure points for each of the generated departure point clusters. For example, in the example illustrated in FIG. 9, as a result of, for trip data classified into the departure point cluster whose cluster ID is “ID_S1”, performing clustering of times at departure points in the trip data, three departure time clusters whose respective clusters ID are “ID_T1”, “ID_T2” and “ID_T3” are generated. For each of trip data in the departure time clusters of “ID_S2” and “ID_S3”, likewise, the extraction section 572 performs clustering of times at departure points to generate a departure time cluster.

Next, the extraction section 572 performs clustering of coordinate information pieces of arrival points for each of the generated departure time clusters. For example, in the example illustrated in FIG. 9, as a result of, for trip data classified into the departure time cluster whose cluster ID is “ID_T1”, coordinate information pieces of arrival points in the trip data, four arrival point clusters whose respective cluster IDs are “ID_D1”, “ID_D2”, “ID_D3” and “ID_D4” are generated. For each of trip data in the departure time clusters of “ID_T2” and “ID_T3”, likewise, the extraction section 572 performs clustering of coordinate information pieces of arrival points to generate an arrival point cluster.

After the generation of the arrival point clusters, the extraction section 572 detects arrival point clusters that are high ranked in number of trip data included in the arrival point cluster. For example, the extraction section 572 detects arrival point clusters that are ranked first and second in number of trip data included in the arrival point cluster. The present embodiment will be described in terms of a case where arrival point clusters ranked first and second in number of trip data included; however, arrival point clusters ranked first to third or first to fifth in number of trip data may be detected. Arrival point clusters extracted by the extraction section 572 correspond to second candidate areas.

For each of the first candidate areas and the second candidate areas extracted by the extraction section 572, the acquisition section 573 acquires usage information of land included in the candidate area from the area usage database 537. In other words, for each of the departure point clusters and the arrival point clusters extracted by the extraction section 572, the acquisition section 573 acquires usage information of land including coordinate information pieces classified into the cluster, from the area usage database 537.

The representative point determination section 574 determines respective representative points of each of the departure point clusters, which are first candidate areas, and each of the arrival point clusters, which are second candidate areas.

For example, description will be provided assuming that the extraction section 572 has extracted the cluster having a cluster ID of “ID_D1”, which is illustrated in FIG. 9, as an arrival point cluster. The representative point determination section 574 obtains an average value of latitudes and longitudes in coordinate information pieces of arrival points included in the arrival point cluster of “ID_D1” and determines the obtained average value as a representative point of the arrival point cluster. Alternatively, the representative point determination section 574 may extract a predetermined number of arrival points included in the arrival point cluster whose cluster ID is “ID_D1”, obtain an average value of coordinate information pieces of the predetermined number of arrival points extracted and determine the obtained average value of the coordinate information pieces as a representative point of the arrival points.

For departure points in trip data included in the arrival point cluster, likewise, the representative point determination section 574 obtains an average value of latitudes and longitudes of coordinate information pieces of the departure points and determines the obtained average value as a representative point of the departure point cluster. Alternatively, the representative point determination section 574 may extract a predetermined number of departure points from the departure points in the trip data included in the arrival point cluster, obtain an average value of coordinate information pieces of the predetermined number of departure points extracted and determine the obtained average value of the coordinate information pieces as a representative point of the departure points.

The estimation section 575 estimates an intended candidate area from the arrival point clusters extracted by the extraction section 572. Examples of the intended candidate area include candidate areas in which a house or a workplace of a user is located.

First, the estimation section 575 calculates an average value of staying time lengths in which the vehicle 35 stayed at the departure points and an average value of time lengths in which the vehicle 35 stayed at the arrival points, respectively, with reference to the times included in the trip data.

More specifically, the estimation section 575 calculates a staying time length for each of a plurality of departure points (hereinafter referred to as “departure point group”) in each of the trip data belonging to the arrival point clusters, with reference to the position database 533. The estimation section 575 calculates a staying time length of staying at each departure point, with reference to a record in which a coordinate information piece that is the same as a coordinate information piece of the departure point is registered as an arrival point. After the calculation of the respective staying time lengths for the departure point group, the estimation section 575 calculates an average value of the calculated staying time lengths. The calculated average value of the staying time lengths is a staying time length for the departure point group.

Likewise, the estimation section 575 calculates a staying time length for each of a plurality of arrival points (hereinafter referred to as “arrival point group”) in each of the trip data belonging to the arrival point clusters, with reference to the position database 533. The estimation section 575 calculates a staying time length of staying at each arrival point, with reference to a record in which a coordinate information piece that is the same as a coordinate information piece of the arrival point is registered as a departure point. After the calculation of the respective staying time lengths for the arrival point group, the estimation section 575 calculates an average value of the calculated staying time lengths. The calculated average value of the staying time lengths is a staying time length for the arrival point group.

Next, the estimation section 575 compares the calculated average values of the staying time lengths for the departure point group and the arrival point group with a set time length set in advance. If the average value of the staying time lengths for the departure point group is shorter than the set time length, the estimation section 575 excludes the departure point cluster including the departure point group from candidate areas in which the house or the workplace of the user is located. Likewise, if the average value of the staying time lengths for the arrival point group is shorter than the set time length, the estimation section 575 excludes the arrival point cluster including the arrival point group from candidate areas in which the house or the workplace of the user is located.

Also, if the estimation section 575 detects a spot group, an average value of staying time lengths for the spot group being longer than the set time length set in advance, the estimation section 575 acquires usage information of land identified by coordinate information pieces of the detected spot group, with reference to the area usage database 537. The spot group here is a departure point group or an arrival point group, an average value of staying time lengths for the departure point group or the arrival point group being longer than the set time length, or a general term of such departure point group and such arrival point group. If the usage information acquired from the area usage database 537 indicates “residential area”, the estimation section 575 estimates a cluster of the detected spot group (departure point cluster or arrival point cluster) as a candidate of an area in which the house of the user is located. Also, the estimation section 575 estimates a representative point of the spot group, the representative point being determined by the representative point determination section 574, as the house of the user.

Also, if the usage information acquired from the area usage database 537 indicates “business area”, the estimation section 575 estimates a cluster of the detected spot group (departure point cluster or arrival point cluster) as a candidate of an area in which the workplace of the user is located. Also, the estimation section 575 estimates a representative point of the spot group, the representative point being determined by the representative point determination section 574, as the workplace of the user.

Also, the estimation section 575 may determine whether or not a coordinate information piece associated with an SSID is registered within a predetermined range from the representative point of the cluster that the detected spot group belongs to, with reference to the position database 533.

Even though the usage information of the land identified by the coordinate information pieces of the spot group indicates “residential area”, if a coordinate information piece associated with an SSID is registered within a predetermined range from the representative point and a facility word is included in the registered SSID, the estimation section 575 does not estimate the cluster that the detected spot group belongs to, as a candidate of the area in which the house of the user is located. An SSID including a facility word is often an SSID of a shop or a facility in a business area. Therefore, the estimation section 575 does not estimate the cluster that the spot group belongs to, as a candidate of the area in which the house of the user is located.

Also, if the usage information of the land identified by the coordinate information pieces of the spot group indicates “residential area” and no coordinate information piece associated with an SSID is registered within a predetermined range from the representative point or if the registered SSID includes no facility word, the estimation section 575 estimates the cluster that the detected spot group belongs to, as a candidate of the area in which the house of the user is located.

Also, even though the usage information of the land identified by the coordinate information pieces of the spot group indicates “business area”, if no coordinate information piece associated with an SSID is registered within a predetermined range from the representative point or if the registered SSID includes no facility word, the estimation section 575 estimates the cluster that the detected spot group belongs to, as a candidate of an area in which the workplace of the user is located.

Also, if the usage information of the land identified by the coordinate information piece of the spot group indicates “business area” and a coordinate information piece associated with an SSID is registered within a predetermined range from the representative point and the registered SSID includes a facility word, the estimation section 575 estimates the cluster that the detected spot group belongs to, as a candidate of the area in which the workplace of the user is located.

The estimation section 575 registers coordinate information and site information in association with each other in the site registration table 535. The estimation section 575 registers the representative point of the candidate area selected as a candidate of the area in which the house of the user is located, as the coordinate information. Also, the estimation section 575 registers “house” as the site information piece associated with the coordinate information piece. Also, the estimation section 575 registers the representative point of the candidate area selected as a candidate of the area in which the workplace of the user is located, as the coordinate information. Also, “workplace” is registered as the site information piece associated with the coordinate information piece.

The retrieval section 576 retrieves coordinate information registered in the position database 533, the coordinate information being related to a spot indicated by coordinate information not estimated as the house or the workplace of the user by the estimation section 575. For example, the retrieval section 576 retrieves, e.g., an address of the spot indicated by the coordinate information or a facility name of a facility present at the spot. Also, if there are a plurality of shops within the retrieved facility, the retrieval section 576 retrieves shop names of the plurality of shops. The retrieval section 576 registers the retrieved shop names in the site registration table 535. A function that retrieves an address of a spot indicated by position coordinates is provided by, for example, implementation of a geocoding API provided by Google (registered trademark) in the server apparatus 50.

The estimation section 575 acquires an SSID of coordinate information with the SSID associated thereto, from which the plurality of shop names have been retrieved by the retrieval section 576, with reference to the position database 533. The estimation section 575 determines whether or not there is a facility name matching with a facility word included in the acquired SSID in the facility names retrieved by the retrieval section 576. If there is a facility name matching a facility word in the SSID, the estimation section 575 leaves the facility name only and deletes the other facility names from the site registration table 535. For example, if only position coordinates are not enough to identify a shop the user visited, the estimation section 575 selects a shop name of a shop the user visited, based on the facility word included in the SSID. Consequently, the shop name of the shop the user visited can be displayed on, e.g., a map.

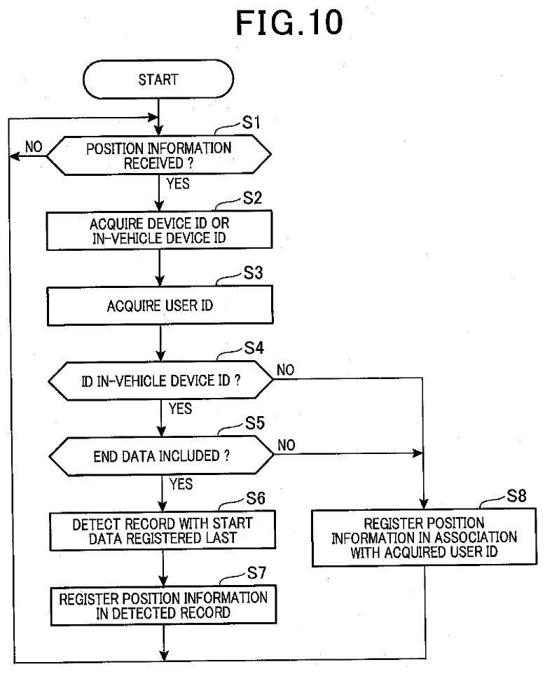

FIG. 10 is a flowchart illustrating operation of the server apparatus 50 upon receiving position information.

First, the control section 550 determines whether or not position information is received from a mobile device 10 or an in-vehicle device 30 (step S1). If no position information is received (step S1/NO), the control section 550 waits until reception of position information.

Also, if position information is received (step S1/YES), the control section 550 acquires a device ID or an in-vehicle device ID included in the received position information (step S2). The control section 550 acquires a user ID associated with the acquired ID or in-vehicle device ID, with reference to the user management table 531 (step S3).

Next, the control section 550 determines whether or not the ID acquired from the position information in step S2 is an in-vehicle device ID (step S4). If the ID is an in-vehicle device ID (step S4/YES), the control section 550 determines whether or not end data is included in the position information (step S5).

If end data is included in the position information (step S5/YES), the control section 550 searches the position database 533 to detect a record associated with the user ID acquired in step S3, the record being a record last registered as start data (step S6). After the detection of such record, the control section 550 registers the received position information in the detected record in the position database 533 (step S7).

Also, if it is determined in step S5 that no end data is included in the position information (step S5/NO) or if it is determined in step S4 that the ID is not an in-vehicle device ID but a device ID (step S4/NO), the control section 550 registers the position information in association with the acquired user ID (step S8). Subsequently, the control section 550 returns to step S1 and waits until reception of position information.

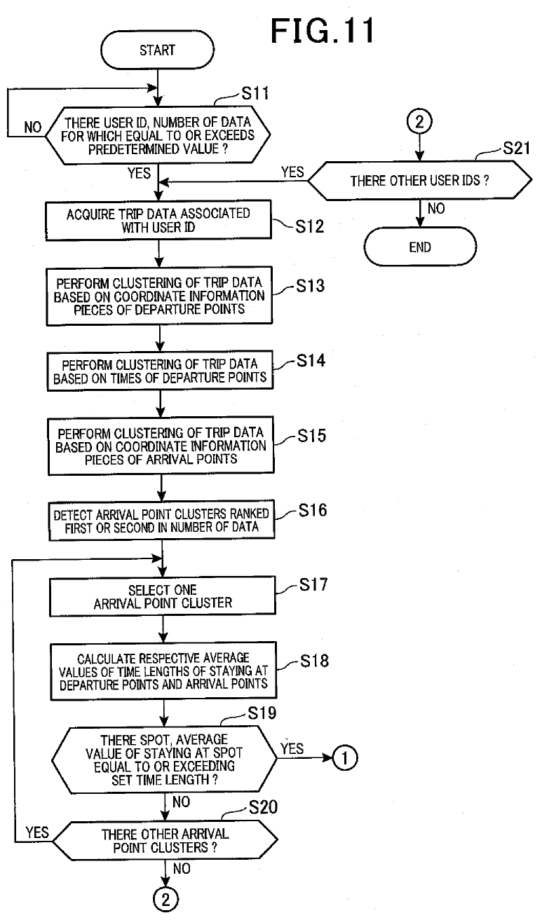

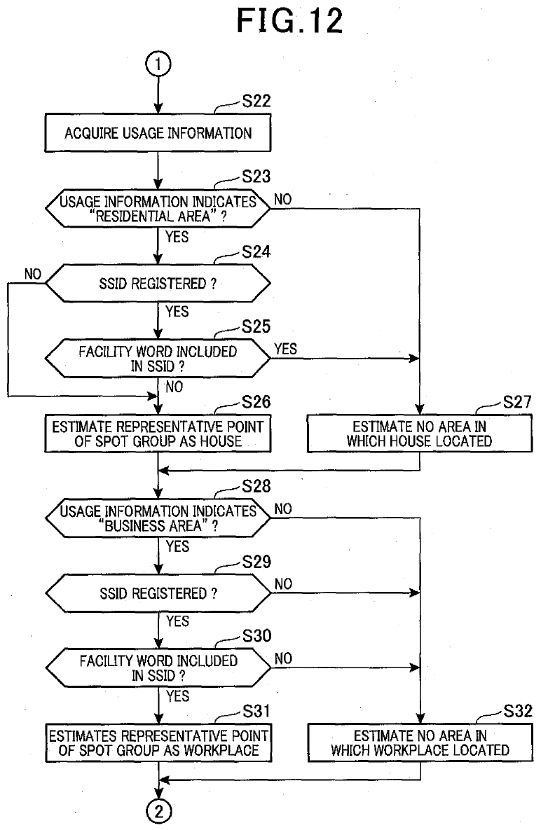

FIGS. 11 and 12 are flowcharts illustrating a processing procedure of processing for the server apparatus 50 to estimate a house and a workplace of a user.

A processing procedure for estimating a house and a workplace of a user will be described with reference to the flowcharts illustrated in FIGS. 11 and 12.

First, the control section 550 determines whether or not there is a user ID, the number of data registered in the position database 533 for the user ID being equal to or exceeding a predetermined value. If there is no user ID, the number of data for the user ID being equal to or exceeding the predetermined value (step S11/NO), the control section 550 waits until detection of a user ID, the number of data registered for the user ID being equal to or exceeding the predetermined value.

If there is a user ID, the number of data registered for the user ID being equal to or exceeding the predetermined value (step S11/YES), the control section 550 acquires trip data registered in association with the user ID from the position database 533 (step S12). The control section 550 performs clustering of the acquired trip data and extracts trip data classified into clusters that are high ranked in number of data.

First, the control section 550 performs clustering of coordinate information pieces of departure points included in the trip data (step S13) to generate departure point clusters. Next, for each departure point cluster, the control section 550 performs clustering of times at the departure points in trip data classified into the departure point cluster to generate departure time clusters (step S14). Furthermore, for each departure time cluster, the control section 550 performs clustering of coordinate information pieces of arrival points in trip data classified into the departure time cluster to generate arrival point clusters (step S15).

After the generation of the arrival point clusters, the control section 550 detects arrival point clusters that are ranked first and second in number of trip data included in the relevant arrival point cluster (step S16). After the detection of the arrival point clusters, the control section 550 selects one of the detected arrival point clusters (step S17). After the selection of the arrival point cluster, the control section 550 calculates an average value of staying time lengths of staying in a departure point group and an average value of staying time lengths of staying in an arrival point group, respectively. For each of a plurality of trip data belonging to the selected arrival point cluster, the control section 550 calculates a staying time length of staying at a relevant departure point and a staying time length of staying at a relevant arrival point, respectively. The control section 550 calculates an average value of the plurality of calculated departure point staying time lengths and an average value of the plurality of calculated arrival point staying time lengths (step S18).

Next, the control section 550 compares the average value of the staying time lengths for the departure point group and the average value of the staying time lengths for the arrival point group with a set time length set in advance to determine whether or not each of the average values of the staying time lengths are equal to or exceed the set time length (step S20).

If the average values of the staying time lengths for the departure points and the arrival points are both shorter than the set time length (step S19/NO), the control section 550 determines whether or not there is a next arrival point cluster (step S20). If there is no other arrival point cluster (step S20/NO), the control section 550 determines whether or not there is a user ID, the number of data registered for the user ID being equal to or exceeding the predetermined value (step S21). If there is another user ID (step S22/YES), the control section 550 returns to the processing in step S12 and acquires trip data for the user ID from the position database 533. Also, if there are other arrival point clusters (step S20/YES), the control section 550 returns to step S17 and selects one arrival point cluster.

Also, at least one of the average value of the staying time lengths for the departure point group and the average value of the staying time lengths for the arrival point group is equal to or exceeds the set time length (step S19/YES), the control section 550 acquires usage information of land (step S22). The departure point group or the arrival point group determined as the average value of the staying time lengths for the departure point group or the arrival point group being equal to or exceeding the set time length in the determination in step S19, or such departure point group and such arrival point group is referred to as “spot group”. The control section 550 acquires usage information of land identified by coordinate information of the spot group determined as the average value of the staying time lengths for the spot group being equal to or exceeding the set time length, with reference to the area usage database 537 (step S22).

The control section 550 determines whether or not the acquired usage information indicates “residential area” (step S23). If the usage information does not indicate “residential area” (step S23/NO), the control section 550 does not perform estimation of an area in which a house of a user is located (step S27).

Also, if the acquired usage information indicates “residential area” (step S23/YES), the control section 550 determines whether or not coordinate information associated with an SSID is registered within a predetermined range from the representative point of the cluster that the spot group belongs to (step S24). If no such SSID is registered in the position database 533 (step S24/NO), the control section 550 estimates the representative point of the spot group as the house of the user (step S26).

Also, if such SSID is registered in the position database 533 (step S24/YES), the control section 550 determines whether or not a facility word is included in the SSID (step S25). If no facility word is included in the SSID (step S25/NO), the control section 550 estimates the representative point of the spot group as the house of the user (step S26). Also, if a facility word is included in the SSID (step S25/YES), the control section 550 does not estimate a candidate of the area in which the house of the user is located.

Next, the control section 550 determines whether or not the usage information acquired in step S22 indicates “business area” (step S28). If the usage information does not indicate “business area” (step S28/NO), the control section 550 does not estimate a candidate of an area in which the workplace is located (step S32).

Also, if the usage information indicates “business area” (step S28/YES), the control section 550 determines whether or not coordinate information associated with the SSID is registered within a predetermined range from the representative point of the cluster that the spot group belongs to (step S29). If no such SSID is registered in the position database 533 (step S29/NO), the control section 550 does not estimate a candidate of the area in which the workplace is located (step S32).

Also, if such SSID is registered in the position database 533 (step S29/YES), the control section 550 determines whether or not a facility word is included in the SSID (step S30). If no facility word is included in the SSID (step S30/NO), the control section 550 does not estimate a candidate of the area in which the workplace is located (step S32). Also, if a facility word is included in the SSID (step S30/YES), the control section 550 estimates the representative point of the spot group as the workplace (step S31).

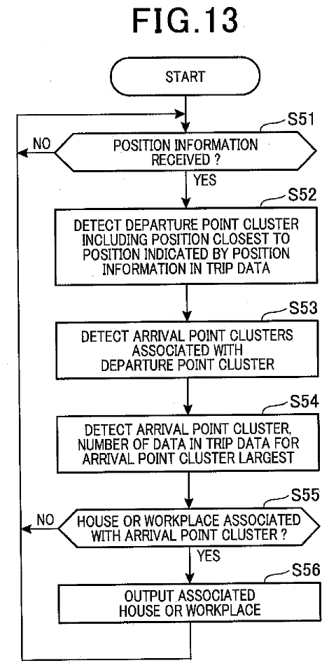

FIG. 13 is a flowchart illustrating operation of the server apparatus 50 upon receiving position information from a mobile device 10 or an in-vehicle device 30.

The control section 550 determines whether or not position information is received from an in-vehicle device 30 (step S51). If no position information is received from an in-vehicle device 30 (step S51/NO), the control section 550 waits until reception of position information.

Also, if position information is received (step S51/YES), the control section 550 detects a departure point cluster including a position closest to a position indicated by the received position information in trip data (step S52). The departure point cluster detected here is a departure point cluster generated by the above-described clustering in step S14, and for example, in the example illustrated in FIG. 9, is any of those of cluster IDs of “ID_S1”, “ID_S2” and “ID_S3”.

Next, the control section 550 detects arrival point clusters associated with the detected departure point cluster (step S53). For example, in the example illustrated in FIG. 9, where a departure point cluster with a cluster ID of “ID_S1” is selected as a departure point cluster, the arrival point clusters are arrival point clusters having any of cluster IDs of “ID_D1” to “ID_D7” resulting from clustering of trip data included in the departure point cluster.

Next, the control section 550 detects an arrival point cluster, the number of data in trip data for the arrival point cluster being largest, from among the detected arrival point clusters (step S54). After the detection of the arrival point cluster, the control section 550 determines whether or not a house or a workplace of a relevant user is associated with the detected arrival point cluster (step S55). If neither the house nor the workplace of the user is associated with the arrival point cluster (step S55/NO), the control section 550 performs no output. Also, if the house or the workplace of the user is associated with the arrival point cluster (step S55/YES), the control section 550 outputs the associated house or workplace of the user and coordinate information of the house or workplace (step S56).

As described above, the server apparatus 50 according to the present embodiment includes the communication section 510, the data management section 571, the extraction section 572, the acquisition section 573 and the estimation section 575.

The data management section 571 functions as a generation section that based on position information pieces received from an in-vehicle device 30 by the communication section 510, generates trip data including position information pieces of departure points and arrival points of a vehicle 35 in which the in-vehicle device 30 is mounted.

The extraction section 572, based on the trip data, extracts a plurality of first candidate areas, the number of position information pieces set as departure points for each of the first candidate areas being equal to or exceeding a predetermined value, and for each of the plurality of first candidate areas, second candidate areas, the number of position information pieces set as arrival points for each of second candidate areas at the time of departure from the departure points in the first candidate area being equal to or exceeding a predetermined value.

The acquisition section 573 acquires usage information pieces of lands including the first candidate areas and usage information pieces of lands including the second candidate areas.

The estimation section 575 estimates an intended candidate area based on the usage information pieces acquired by the acquisition section 573, the number of position information pieces of departure points included in each first candidate area and the number of position information pieces of arrival points included in each second candidate area.

As described above, the server apparatus 50 extracts a plurality of first candidate areas, the number of times of setting a departure point in each of the plurality of first candidate areas being equal to or exceeding a predetermined value, and second candidate areas, the number of times of setting arrival points in the second candidate areas when the first candidate area is set as a departure point being equal to or exceeding a predetermined value, and extracts an intended candidate area based on usage information pieces of lands in the extracted first candidate areas and second candidate areas. Therefore, accuracy of identification of sites frequently set as a departure point or an arrival point such as a house or a workplace can be enhanced.

The extraction section 572 performs clustering of the first candidate areas and the second candidate areas using trip data as learning data.

Therefore, the clustering enables enhancement in accuracy of extraction of the first candidate areas and the second candidate areas.

The extraction section 572 performs clustering of the learning data via machine learning.

Therefore, the accuracy of extraction of the first candidate areas and the second candidate areas can further be enhanced.

The estimation section 575 estimates a first candidate area or a second candidate area that has the usage information piece acquired by the acquisition section 573 indicating “residential area”, and the largest number of position information pieces of departure points and arrival points, as a house area in which a house of a user of the vehicle 35 is located, and estimates a position of the house based on the position information pieces included in the first candidate area or the position information pieces included in the second candidate area.

Therefore, accuracy of estimation of the house area in which the house of the user is located and the position of the house can be enhanced.

The estimation section 575 estimates a first candidate area or a second candidate area that has the usage information piece acquired by the acquisition section 573 indicating “business area”, and the largest number of position information pieces of departure points and arrival points, as a workplace area in which a workplace of the user of the vehicle 35 is located, and estimates a position of the workplace based on the position information pieces included in the first candidate area or the position information pieces included in the second candidate area.

Therefore, accuracy of estimation of the workplace area in which the workplace of the user is located and the position of the workplace can be enhanced.

The estimation section 575 excludes a first candidate area and a second candidate area with time lengths of parking of the vehicle 35 in each of the first candidate area and the second candidate area being equal to or below a set time length set in advance, from among the plurality of first candidate areas and second candidate areas extracted by the extraction section 572, from candidates for estimation of an intended candidate area.

Therefore, when a house or a workplace is estimated, excluding candidate areas, time length of parking in each of the candidate areas being equal to or below a set time length, enables enhancement in accuracy of estimation of the house or the workplace.

The communication section 510 receives an SSID, which is identification information of a wireless network to which a mobile device 10 carried by the user of the vehicle 35 is connected, and a position information piece, from the mobile device 10.

The estimation section 575 excludes a first candidate area and a second candidate area, the identification information of each of the first candidate area and the second candidate area including a word related to a facility name, from among the plurality of first candidate areas and second candidate areas extracted by the extraction section 572, from candidates for the house area.

Therefore, an area including a word related to a facility name often has an SSID for a shop or a facility in a business area. Therefore, when a house area is estimated, excluding candidate areas, an SSID for each of candidate areas including a word related to a facility name, from candidates for the house area enables enhancement in accuracy of estimation of the house area and the house.

Also, the estimation section 575 excludes a first candidate area and a second candidate area, the identification information of each of the first candidate area and the second candidate area including no word related to a facility name, from among the plurality of first candidate areas and second candidate areas extracted by the extraction section 572, from candidates for the workplace area.

For a reason that is similar to the above, when a workplace area is estimated, excluding candidate areas, an SSID of each of the candidate areas including no word related to a facility name, from candidates for the workplace area enables enhancement in accuracy of estimation of the workplace area and the workplace.

Also, the server apparatus 50 includes the storage section 530 that stores the area usage database 537 in which usage of each area is registered.

Therefore, it is possible to acquire usage of an area without communication with an external apparatus.

Also, the server apparatus 50 retrieves a facility name of a facility present at a position indicated by position information. Then, if the position indicated by the position information is a position, for which a plurality of facility names have been retrieved, the server apparatus 50 selects one facility name based on a word included in identification information. Then, the server apparatus 50 associates the selected facility name with the position information.

Accordingly, the facility the user came by can be associated with the position indicated by the position information.

### Second Embodiment

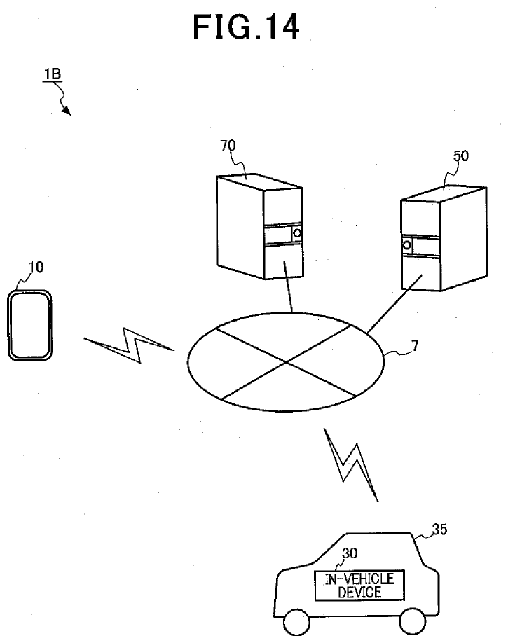

FIG. 14 is a system configuration diagram according to a second embodiment of the present invention.

A system 1B according to the second embodiment includes a server apparatus 70 in addition to a server apparatus 50. In the second embodiment, an area usage database 537 stored in a storage section 530 of a server apparatus 50 is stored in a server apparatus 70.

The server apparatus 50 reads coordinate information pieces in a record associated with a selected user ID and extracts first candidate areas and second candidate areas. After the extraction of the first candidate areas and the second candidate areas, the server apparatus 50 transmits coordinate information pieces in trip data included in the extracted first candidate areas and second candidate areas to the server apparatus 70.

The server apparatus 70 acquires usage information pieces for areas including coordinate information pieces received from the server apparatus 50, with reference to the area usage database 537. The server apparatus 70 transmits the acquired usage information pieces to the server apparatus 50.

The server apparatus 50 estimates a house or a workplace of a user based on the usage information pieces received from the server apparatus 70 and the number of data in each of trip data classified into the second candidate areas.

The second embodiment also enables provision of effects that are the same as those of the first embodiment.

Each of the above embodiments merely indicates an aspect of the present invention and arbitrary alterations and applications are possible without departing of the spirit of the present invention.

For example, although each of the first and second embodiments described above has been described in terms of an example in which estimation of a house and a workplace of a user is performed in the server apparatus 50, a house and a workplace of a user can be estimated in a mobile device 10 or an in-vehicle device 30 by means of operation similar to that of the server apparatus 50.

Also, the functional blocks of the server apparatus 50 illustrated in FIG. 4 are schematic ones illustrated by classification of functions of the server apparatus 50 according to respective main processing contents. The components of the server apparatus 50 can further be divided into more blocks according to respective processing contents. Also, the functional blocks may be configured in such a manner that more types of processing can be performed by one block illustrated in FIG. 4. Also, the processing in each block may be performed by a single piece of hardware or a plurality of pieces of hardware. Also, the processing in each block may be provided by a single program or may be provided by a plurality of programs. Also, each of the components of the mobile device 10 illustrated in FIG. 2 and the components of the in-vehicle device 30 illustrated in FIG. 3 can further be divided into more blocks according to respective processing contents.

Also, units of processing in the flowchart illustrated in FIGS. 10 to 13 are ones resulting from the processing in the control section 550 of the server apparatus 50 being divided according to respective main processing contents for ease of understanding, and the present invention is limited by neither a manner of division of units of processing nor names of the units of processing.

Also, the processing in the server apparatus 50 can further be divided into more units of processing according to respective processing contents or can be divided so that one unit of processing includes more types of processing. Also, the order of steps of processing in the above flowchart is not limited to the order in the illustrated example.

Also, where the information processing method is provided by a computer, a program to be executed by the computer can be provided in the form of a recording medium or a transmission medium that transmits a program. For the recording medium, a magnetic or optical recording medium or a semiconductor storage device may be used. More specifically, examples of the recording medium include a flexible disk, an HDD (hard disk drive), a CD-ROM (compact disk read-only memory), a DVD, a Blu-ray (registered trademark) disc and a magnetooptical disk. Also, examples of the recording medium can include a flash memory, a portable recording medium such as a card-type recording medium and a fixed recording medium. Also, the recording medium may be a non-volatile storage device, such as a RAM, a ROM or an HDD, that is an internal storage device included in an information processing apparatus.

### REFERENCE SIGNS LIST

1A, 1B system
7 communication network
10 mobile device
30 in-vehicle device
35 vehicle
50, 70 server apparatus
111 wireless communication section
112 mobile communication section
113 GPS reception section
114 sensors
115 interface
116, 315 display section
117, 316 operation section
118, 317 voice processing section
119, 318 speaker
120, 335 microphone
130, 320, 550 control section
140, 330, 560 memory
145, 335, 565 control program
150, 340, 570 processor
311 wireless communication section
312 GPS reception section
313 map data storage section
314 interface
510 communication section
530 storage section
531 user management table
533 position database
535 site registration table
537 area usage database
571 data management section
572 extraction section
573 acquisition section
574 representative point determination section
575 estimation section
576 retrieval section

What is claimed is:

1. An information processing apparatus comprising:
a communication section;
a generation section that based on position information pieces received by the communication section from an in-vehicle device, generates trip data including position information pieces of departure points and arrival points of a vehicle in which the in-vehicle device is mounted;
an extraction section that based on the trip data, extracts a plurality of first candidate areas associated with position information pieces set as departure points, a number of which is equal to or exceeding a predetermined value, and for each of the plurality of first candidate areas, second candidate areas associated with position information pieces set as arrival points, a number of which is equal to or exceeding a predetermined value, in a case of departure from the departure points in the first candidate area;
an acquisition section that acquires usage information pieces of lands including the first candidate areas and usage information pieces of lands including the second candidate areas; and
an estimation section that estimates an intended candidate area based on the usage information pieces acquired by the acquisition section, the number of position information pieces of departure points included in the first candidate areas and the number of position information pieces of arrival points included in the second candidate areas.

2. The information processing apparatus according to claim 1, wherein the extraction section performs clustering of the first candidate areas and the second candidate areas using the trip data as learning data.

3. The information processing apparatus according to claim 2, wherein the extraction section performs clustering of the learning data via mechanical learning.

4. The information processing apparatus according to claim 1, wherein the estimation section estimates a first candidate area or a second candidate area that has the usage information piece acquired by the acquisition section indicating a residential area, and a largest number of position information pieces of departure points and arrival points, as a house area in which a house of a user of the vehicle is located, and estimates a position of the house based on the position information pieces included in the first candidate area or the position information pieces included in the second candidate area.

5. The information processing apparatus according to claim 1, wherein the estimation section estimates a first candidate area or a second candidate area that has the usage information piece acquired by the acquisition section indicating a business area, and a largest number of position information pieces of departure points and arrival points, as a workplace area in which a workplace of the user of the vehicle is located, and estimates a position of the workplace based on the position information pieces included in the first candidate area or the position information pieces included in the second candidate area.

6. The information processing apparatus according to claim 1, wherein the estimation section excludes a first candidate area and a second candidate area with time lengths of parking of the vehicle in each of the first candidate area and the second candidate area being equal to or below a set time length set in advance, from among the plurality of first candidate areas and second candidate areas extracted by the extraction section, from candidates for estimation of the intended candidate area.

7. The information processing apparatus according to claim 4, wherein:
the communication section receives, from the mobile device: identification information for identifying a wireless network to which a mobile device carried by the user of the vehicle was connected; and a position information piece; and
the estimation section excludes a first candidate area and a second candidate area, the identification information of each of the first candidate area and the second candidate area including a word related to a facility name, from among the plurality of first candidate areas and second candidate areas extracted by the extraction section, from candidates for the house area.

8. The information processing apparatus according to claim 5, wherein:
the communication section receives, from the mobile device: identification information for identifying a wireless network to which a mobile device carried by the user of the vehicle was connected; and a position information piece; and
the estimation section excludes a first candidate area and a second candidate area, the identification information of each of the first candidate area and the second candidate area including no word related to a facility name, from among the plurality of first candidate areas and second candidate areas extracted by the extraction section, from candidates for the workplace area.

9. The information processing apparatus according to claim 1, comprising a storage section that stores a database registering usage for each area,
wherein the acquisition section acquires the usage information pieces with reference to the database stored in the storage section.

10. The information processing apparatus according to claim 1, wherein the acquisition section controls the communication section to transmit the position information pieces to an external apparatus that stores a database registering usage for each area and receive usage information pieces of areas including the positions indicated by the position information pieces from the external apparatus, the usage information pieces being transmitted from the external apparatus.

11. An information processing method comprising:
a step of receiving position information pieces from an in-vehicle device mounted in a vehicle;
a step of generating, based on the received position information pieces, trip data including position information pieces of departure points and arrival points of the vehicle in which the in-vehicle device is mounted;
a step of extracting, based on the trip data, a plurality of first candidate areas associated with position information pieces set as departure points, a number of which is equal to or exceeding a predetermined value, and for each of the plurality of first candidate areas, second candidate areas associated with position information pieces set as arrival points, a number of which is equal to or exceeding a predetermined value, in a case of departure from the departure points in the first candidate area;
a step of acquiring usage information pieces of lands including the first candidate areas and usage information pieces of lands including the second candidate areas; and
a step of estimating an intended candidate area based on the acquired usage information pieces, the number of position information pieces of departure points included in the first candidate areas and the number of position information pieces of arrival points included in the second candidate areas.

12. The information processing method according to claim 11, wherein the step of extracting includes performing clustering of the first candidate areas and the second candidate areas using the trip data as learning data.

13. The information processing method according to claim 12, wherein the step of extracting includes performing clustering of the learning data via mechanical learning.

14. The information processing method according to claim 11, wherein the step of estimating includes estimating a first candidate area or a second candidate area that has the acquired usage information piece indicating a residential area, and a largest number of position information pieces of departure points and arrival points, as a house area in which a house of a user of the vehicle is located, and estimating a position of the house based on the position information pieces included in the first candidate area or the position information pieces included in the second candidate area.

15. The information processing method according to claim 11, wherein the step of estimating includes estimating a first candidate area or a second candidate area that has the acquired usage information piece indicating a business area, and a largest number of position information pieces of departure points and arrival points, as a workplace area in which a workplace of the user of the vehicle is located, and estimating a position of the workplace based on the position information pieces included in the first candidate area or the position information pieces included in the second candidate area.

16. The information processing method according to claim 11, wherein the step of estimating includes excluding a first candidate area and a second candidate area with time lengths of parking of the vehicle in each of the first candidate area and the second candidate area being equal to or below a set time length set in advance, from among the plurality of first candidate areas and second candidate areas extracted by the step of extracting, from candidates for estimation of the intended candidate area.

17. The information processing method according to claim 14, wherein the step of receiving includes receiving, from the mobile device: identification information for identifying a wireless network to which a mobile device carried by the user of the vehicle was connected; and a position information piece; and
the step of estimating includes excluding a first candidate area and a second candidate area, the identification information of each of the first candidate area and the second candidate area including a word related to a facility name, from among the plurality of first candidate areas and second candidate areas extracted by the step of extracting, from candidates for the house area.

18. The information processing method according to claim 15, wherein:
the step of receiving includes receiving, from the mobile device: identification information for identifying a wireless network to which a mobile device carried by the user of the vehicle was connected; and a position information piece; and
the step of estimating includes excluding a first candidate area and a second candidate area, the identification information of each of the first candidate area and the second candidate area including no word related to a facility name, from among the plurality of first candidate areas and second candidate areas extracted by the step of extracting, from candidates for the workplace area.

19. The method for controlling an information processing apparatus according to claim 17, the method comprising a step of retrieving a facility name of a facility present at a position indicated by a position information piece,
wherein the step of estimating includes, if the position indicated by the position information piece is a position, for which a plurality of facility names have been retrieved by the step of retrieving, selecting one facility name based on the word included in the identification information and associating the selected facility name with the position information piece.

20. The method for controlling an information processing apparatus according to claim 18, the method comprising a step of retrieving a facility name of a facility present at a position indicated by a position information piece,
wherein the step of estimating includes, if the position indicated by the position information piece is a position, for which a plurality of facility names have been retrieved by the step of retrieving, selecting one facility name based on the word included in the identification information and associating the selected facility name with the position information piece.
